(19) United States
(12) Patent Application Publication
(10) Pub. No.: US 2005/0140046 A1
(43) Pub. Date: Jun. 30, 2005

(54) Device for producing multilayer blown film

(75) Inventor: Rolf Hessenbruch, Remschheid (DE)

Correspondence Address: COHEN, PONTANI, LIEBERMAN & PAVANE, 551 FIFTH AVENUE, SUITE 1210, NEW YORK, NY, 10176, US

(73) Assignee: Kiefel Extrusion GmbH

(21) Appl. No.: 11/018,506

(22) Filed: Dec. 21, 2004

(30) Foreign Application Priority Data
Dec. 22, 2003 (DE) 103 60 360.3

(51) Int. Cl. B29C 47/06

(52) U.S. Cl. 264/173.11; 425/133.1; 264/173.16

(57) ABSTRACT

A method for producing multilayer films by the blown film method includes of producing a nine-layer film by combining at least two melt streams and at most three melt streams at each of plural combining locations in a blowing head. The coextrusion blowing head includes a base plate and ten concentric rings defining nine melt channels for the nine individual melt streams. At least two of the concentric rings are supporting rings including flanged attachments for respectively receiving at least one other of the rings. The supporting rings are arranged directly on the base plate.

### BACKGROUND OF THE INVENTION

1. Field of the Invention

The invention relates to a device for producing nine-layered film comprising different polymer layers which are produced by the blown film method.

2. Description of the Related Art

Multilayer films are produced from different polymers to combine the different properties of the individual polymers in one film. These properties are required for the use of the films, for example in the case of food packagings. Barrier properties, welding characteristics and mechanical and thermal properties can be optimized in this way. It is understandable that, as the number of layers increases, so too do the possibilities of achieving optimization. Furthermore, commercial advantages can be achieved by the use of plastics which are inexpensive and easy to process.

The blown film process includes using an extruder to push molten polymer through a die or blowing head which forms an annular shaped film. Films with more than 7 layers are usually produced in blowing heads in which the individual layers are distributed over the circumference by horizontal melt distributions, which are known as pancake design (see, e.g., FIG. 1). The individual layers are fed at offset heights to a central melt channel. Because the individual layer distributions are arranged one above the other, such a blowing head is of a relatively great height, and consequently the central joint flow channel is also very long. This in turn leads to disadvantages from aspects of process technology with regard to the use of different melt viscosities and makes it more difficult to achieve greatly differing layer thicknesses with good layer thickness tolerances. In addition to this there are disadvantages caused by the very great forces occurring in the distribution of the melts over the circumference.

### SUMMARY OF THE INVENTION

An object of the present invention is to provide a method and a blowing head with conventional passage of the melt and that avoids the problems of the prior art. This object is achieved by a method for producing multilayer films by the blown film method, comprising the step of producing a nine-layer film by combining at least two melt streams and at most three melt streams at each of plural combining locations in a blowing head.

The object is also achieved by a coextrusion blowing head for performing the above method, comprising a base plate, and ten concentric rings defining nine melt channels for the nine individual melt streams, at least two of the concentric rings are supporting rings including flanged attachments for respectively receiving at least one other of the rings, the supporting rings being arranged on the base plate.

Important in this respect is the passage of the melt in separate streams and a reunification of the melt which allows a high degree of flexibility with regard to the plastics used and the layer thicknesses. For this purpose, it is necessary to keep the individual melt streams separate for as long as possible, to limit the number of different melt streams that are reunited and to locate where they are reunited as close as possible to the outlet region of the blowing head. It is also important that the reunification of the melt streams takes place in such a way that similar materials are grouped together first and these groups of melts are meaningfully combined with the other, likewise grouped, melt streams.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

In the drawings, wherein like reference characters denote similar elements throughout the several views:

FIG. 1 is a sectional view of a prior art pancake design blowing head with horizontal melt pre-distribution;

FIG. 2 is a sectional view of a known configuration showing blowing head with two points of melt unification;

FIG. 3 is a sectional view of a blowing head according to the invention with three triple and two double melt unifications; and

FIG. 4 is a sectional view of another blowing head according to this invention with four triple points of melt unification.

### DETAILED DESCRIPTION OF THE PRESENTLY PREFERRED EMBODIMENTS

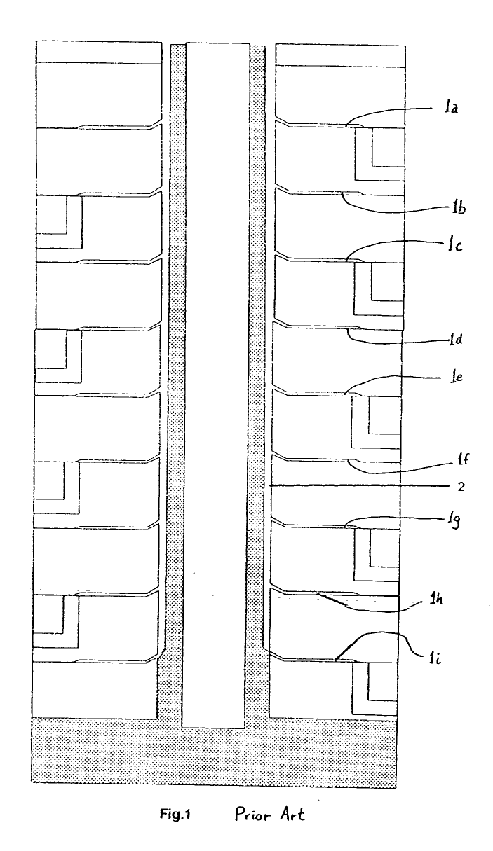

FIG. 1 shows a prior art blowing head with horizontal melt distribution channels 1a-1i over the circumference and the unification of the individual layers in a joint channel 2, the layers of melt being united at offset heights. This type of construction results in a very long joint channel 2 in which the individual layers are united. The long channel restricts the selection of the materials which can be used, because only a limited spectrum of viscosities can be used to avoid instances of mixing or flow irregularities. Furthermore, with the long joint channel 2, instances of separation or changes of tolerances can occur. Furthermore, the forces caused by the melt distribution channels 1 are very great and can only be handled with great effort.

The disadvantages are avoided by blowing heads with conventional passage of melt in which the individual melt streams are reunited not far from the outlet. However, these blowing heads are known only in the form of blowing heads with a maximum of 7 layers, since it has appeared that, with more than 7 layers, the number of layers and the unification of the individual layers cannot be handled.

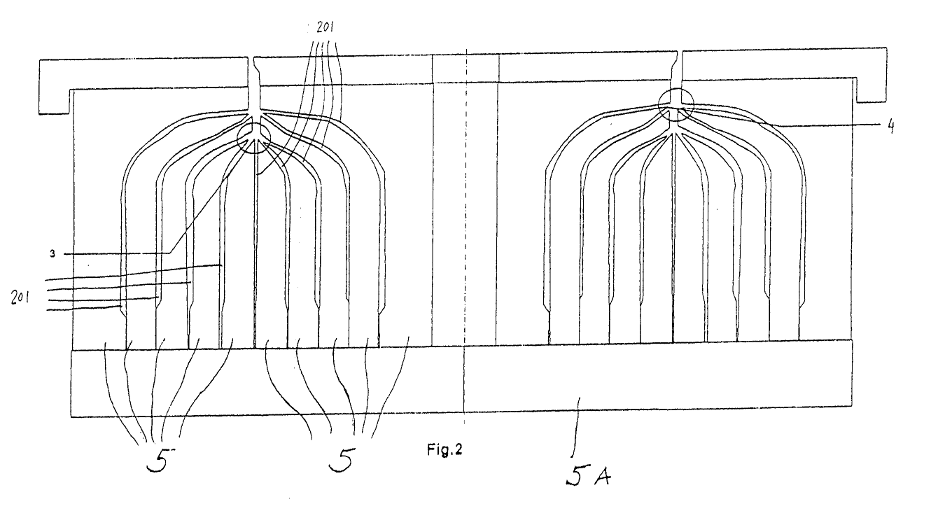

FIG. 2 shows a blowing head with 9 layers according to prior art design, in which it is attempted to unite as many layers as possible at one point. In the present case, five layers are reunited at the point 3. Since the melts consist of different types of raw material, for example adhesion promoters and barrier materials, this solution cannot be used without difficulties, since turbulences can occur at the combining point. Another five layers are reunited at the second combining point 4, specifically four layers obliquely from below and one layer vertically from below, comprising the layers reunited at point 3. The problems mentioned above can occur here too. Furthermore, FIG. 2 shows that individual rings 5 forming the individual melt channels 201 are all mounted on the base plate 5A and, as a result, the tolerances of the individual rings 5 are added together and the maintenance of close tolerances is not ensured. Moreover, mounting, and in particular removal, is very time-consuming and can make disassembly into the individual parts impossible, since removal has to take place at temperatures at which all the polymers still have to be in the plastic state. However, because of the great amount of time required, the individual parts cool down and the polymers solidify, and consequently prevent removal.

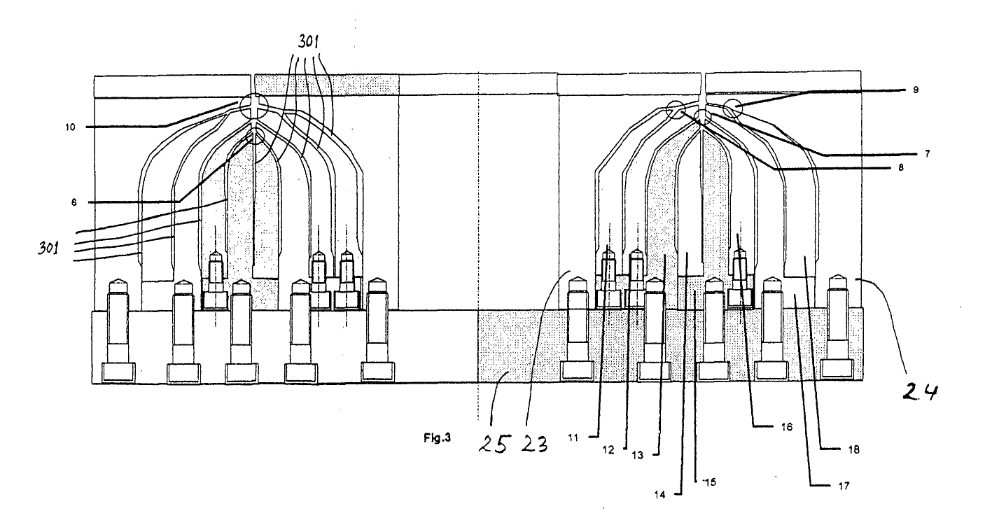

The present invention solves the above-mentioned problems. FIG. 3 shows a nine-layer blowing head in which the individual layers are reunited in such a way that never more than three of the individual melt channels 301 are combined at one point. At the point 6, three inner layers are reunited. Since these materials normally come from the same family of barrier materials, this unification is unproblematical. This melt composite is combined at the point 7 with the next two layers, normally the adhesion promoters. Here, too, three laminar-flowing melt streams are combined, specifically two flows from obliquely below and one flow vertically from below, making up the three flows reunited at point 6. This melt composite, likewise as a laminar flow, in turn meets the melt combination 10 comprising the two inner layers and the two outer layers, which have previously been combined at the points 8 and 9.

The individual rings from which the melt channels are formed are already pre-mounted, and so make easier mounting and removal possible. For instance, the inner rings 11 and 12 are mounted on the supporting ring 13, the rings 14 and 16 are mounted on the supporting ring 15 and the ring 18 is mounted on the supporting ring 17. In respect of mounting and removal, the thee groups of supporting rings 13, 15 and 17 for example are removed and can be simultaneously disassembled at separate locations without the risk of solidification existing. In this blowing head shown in FIG. 3, the rings 11-18 are mounted between an inner ring 23 and an outermost ring 24. The support rings 13, 15, 17 and rings 23, and 24 are mounted directly on a base plate 25 by screws.

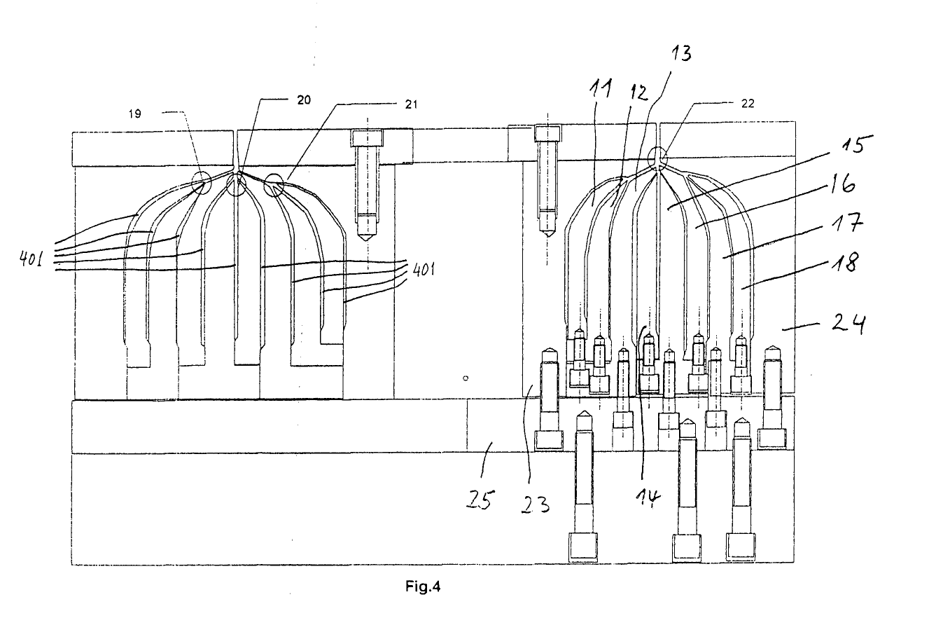

FIG. 4 shows a further embodiment of a nine-layer blowing head, which essentially meets the criteria of the blowing head in FIG. 3, but represents an even better solution for the reunification of the melts. In the case of this blowing head, the nine layers are immediately reunited by three layers respectively being combined at the points 19, 20 and 21 to form a melt composite and combined at a further combining point 22 to form the final composite. It is particularly advantageous in the case of this solution that the melts that are respectively combined belong to similar types of polymer. At the point 19, the three outer layers, which all come from the family of polyolefins (PE and adhesion promoters), are combined. The same applies at the combining point 21, at which three polyolefin layers likewise flow together. At the combining point 20, finally, three polymers which belong to the family of barrier materials (COPA, PA, EVOH) are combined. These melt composites come together as laminar flows at the combining point 22. A further advantage of this solution is that all the layers flow separately for a relatively long distance and only flow together shortly before leaving the blowing head. This avoids instances of mixing of the individual melts due to turbulences which may arise if a number of melt streams flow jointly over relatively long channels. In the case of this solution, polymers which have very different melt viscosities can also be used. Different melt viscosities in turn also make very different layer thicknesses possible. This contributes to an increase in cost-effectiveness, since the layer thicknesses are not determined by the structural design of the blowing head but essentially by the requirements of the packaging task.

The rings which form the melt channels in FIG. 4 are also pre-mounted on supporting rings 13, 15, 17 to exploit the advantages mentioned above. FIG. 4, the same reference numbers have been used, although the individual rings are not formed identically to those according to FIG. 3 in terms of the formation of the combining locations. There are also ten rings present here, with rings 13, 15 and 17 being formed as supporting rings as in FIG. 3, to be able to combine groups of rings into mounting units, which are then mounted on the base plate 25, thereby facilitating mounting and removal.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for producing multilayer films by the blown film method, comprising the steps of:
producing a nine-layer film by combining at least two melt streams and at most three melt streams at each of plural combining locations in a blowing head.

2. The method of claim 1, wherein said step of producing comprises starting from nine individual streams, combining groups of three neighbouring melt streams to form three three-layer melt streams and then combining the three three-layer melt streams.

3. The method of claim 1, wherein said step of producing comprises starting from nine individual streams, combining three of the melt streams to form a three-layer melt stream, combining two individual melt streams with the three-layer melt stream to form a five-layer melt stream, combining groups of two individual melt streams are combined to form two double melt streams, and combining the five-layer melt stream with the two two-layer melt streams to form a nine-layer melt stream.

4. A coextrusion blowing head for performing the method of claim 1, comprising:
a base plate; and
ten concentric rings defining nine melt channels for the nine individual melt streams, at least two of the concentric rings are supporting rings including flanged attachments for respectively receiving at least one other of the rings, and said supporting rings supporting the at least one other of the rings being arranged on said base plate.

5. The coextrusion blowing head of claim 4, wherein respective combining locations for combining the melt streams lie in an upper region of the blowing head and the last combining location is provided in the direct vicinity of a melt flow outlet of the blowing head.

6. The coextrusion blowing head of claim 4, wherein each of the supporting rings is mountable to and other removable from said base plate with the at least one other of the rings as a group of rings, thereby facilitating mounting and removal.
